(19) United States
(12) Patent Application Publication
(10) Pub. No.: US 2006/0000672 A1
(43) Pub. Date: Jan. 5, 2006

(54) Window frame with hidden fire escape

(76) Inventor: James Barbara, Greenwich, CT (US)

Correspondence Address: ANTHONY H. HANDAL;KIRKPATRICK & LOCKHART NICHOLSON GRAHAM LLP, 599 LEXINGTON AVENUE, 33RD FLOOR, NEW YORK, NY, 10022-6030, US

(21) Appl. No.: 11/064,424

(22) Filed: Feb. 23, 2005

Related U.S. Application Data
(63) Continuation-in-part of application No. 10/641,673, filed on Aug. 15, 2003.
(60) Provisional application No. 60/485,916, filed on Jul. 9, 2003.

(51) Int. Cl. A62B 1/06

(52) U.S. Cl. 182/76

(57) ABSTRACT

An improved extruded frame member window incorporating a fire escape or safety ladder as well as methods of manufacture are disclosed. The ladder is discrete and compact, for convenience. The ladder is stored in a hidden container that is an extension or an addition to a normal window, or made part of an existing window, for example by being housed in a containment structure associated with the window. The inventive built-in safety ladder provides for an easy escape in the case of an emergency. The window may be employed in a double-hung window, casement window, awning, slider, hopper, or any operating window which can be used for egress. The fire escape can be incorporated in wood, vinyl, aluminum, fiberglass, steel, and other types of windows. The box may also be used for housing other items such as emergency escape smoke hoods that are used as breathing apparatus, or as a hidden wall safe to store valuables and can be accessed using a security code or other secure access means.

### CROSS REFERENCE TO RELATED APPLICATIONS

This application claims the benefit of Provisional Patent Application No. 60/485,916, filed Jul. 9, 2003, and non-provisional patent application Ser. No. 10/641,673 filed Aug. 15, 2003, the disclosures of which are hereby incorporated herein by reference thereto.

### TECHNICAL FIELD

The invention provides a hidden fire escape that is built into a window frame that is made with modern manufacturing techniques utilizing extruded, injection molded, milled or pulltrusion type products, optionally vinyl, wood, plastic or aluminum profiles, and which stores an escape ladder while maintaining the appearance of a normal window.

### STATEMENT REGARDING FEDERALLY SPONSORED RESEARCH OR DEVELOPMENT

(Not applicable)

### BACKGROUND OF THE INVENTION

The United States has one of the highest fire death rates in the industrialized world. 383,000 residential fires occurred in homes in 2001 resulting in 3,110 fire deaths. Between 1994 and 1998, an average of 4,400 Americans died and another 25,100 were injured in fires. Approximately 80 percent of all fire deaths occur in residences. About two million fires are reported each year. Accordingly, fire-related issues are taken seriously and much work has been devoted to the same. There are ways to help a family survive should a fire occur, and there are many products designed with fire safety in mind, however, none having the same characteristics of the present invention.

A fire can engulf a home in as little as 60 seconds. It is essential that the occupant is prepared with a quick and safe method of escape. Although smoke detectors and heat alarms may warn an occupant, it is still necessary to have a safe method of escape from a burning building. Most tragic accidents occur in residential houses during the night. Occupants are overcome by smoke or find themselves trapped by fire. Therefore, it is extremely important for all homes to have smoke alarms and an alternative means of escape.

Should a fire ignite in the home, escape through the front door may be dangerous or impossible. The only other exit may be a window. There are many escape ladders on the market that can be stored under the bed or in a closet, but there may not be time in an emergency to search for the ladder, or thick smoke may make finding such a ladder impossible.

### SUMMARY OF THE INVENTION

The inventive fire escape remedies this problem. It is built into the window frame itself, making quick access very convenient. In case of an emergency, all one has to do is open the window, lift the cover and throw it from the window and the escape ladder is ready for immediate use.

It also remedies another common problem of intruders using a permanent fire escape as an easy way to gain entry into a home or apartment. Criminals usually have little trouble in accessing exterior fire escapes from the ground level. The inventive fire escape eliminates the worry of taking extra security precautions in connection with windows that have a fire escape permanently attached to the exterior of the building. The hidden fire escape is also a much more economic and easier way to install fire escapes in lieu of permanently attached fire escapes.

The inventive fire escape is built into the window frame itself, reducing crucial time that could be wasted looking for an escape ladder. When not in use, the ladder is out of sight but when it is needed, it can be accessed within seconds. When the bottom sash of the window is lifted, or the casement window cranked open, handles or other types of opening devices are exposed on the sill. When the user pulls the handles up, it releases the escape ladder. The user then throws the lid from the window and the ladder unravels itself. The lid acts as the bottom of the ladder and adds weight to the remaining ladder so it will automatically follow the bottom step out the window when it is thrown. As soon as the entire ladder is released, it is safe for the user to climb down. An alternative is to have the lid hinged. The lid swings open and the ladder becomes visible. The ladder may then be taken in hand by the user and thrown out of the window.

In accordance with yet another alternative, the inventive hidden fire escape may be stored within a part of the operable window, such as the window sash. The hidden fire escape may be stored between two panes of glass in a window or hidden within the sash styles or rails, or sash frame members.

In accordance with the preferred embodiment, the inventive window assembly may incorporate an extruded, injection molded, milled, or pulltrusion member frame. A gasket may be disposed between the frame and they closure member.

In one possible embodiment of the invention, the frame is a flexible vinyl extruded member. An engagement structure is attached to or integral with the closure member and the engagement structure is configured to position the closure member adjacent to the frame.

The inventive window assembly may also comprise a sidewall structure preventing water from entering said hole. They sidewall structure prevents water from entering the hole. In one embodiment, sidewall structure comprises a pair of extruded walls extending the length of the frame, one on the inside or room side of the window frame, and one on the outside or the side facing the environment.

### BRIEF DESCRIPTION OF THE DRAWINGS

One or more embodiments of the invention and ways of making and using the invention, as well as the best mode contemplated of carrying out the invention, are described in detail below, by way of example, with reference to the accompanying drawings, in which:

FIG. 1 is a side view of a closed double-hung window illustrating the improved fire escape stored when not in use;

FIG. 2 is a side view of a window illustrating the design of the present invention where the window is in the opened position and the escape ladder is positioned for use;

FIG. 3 is an enlarged perspective view of a portion of the escape ladder;

FIG. 4 is an isometric view of a portion of the window illustrating how the ladder will be stored when not in use;

FIG. 5 is a perspective view of the invention using the hinged method;

FIG. 6 is a perspective view of the invention having a removable lid;

FIG. 7 is a front view of a casement window illustrating the ladder being released from the top of the frame;

FIG. 8 is a front view of an awning window illustrating the ladder being released from the top of the frame;

FIG. 999 is a perspective cutaway view from the inside of the window of the sill of a double-hung window illustrating the modification of the same to provide an alternative improved window incorporating, a fire escape ladder;

FIG. 10 is a top view of the window sill of the embodiment of FIG. 9, illustrating the access hole provided in accordance with the present invention where the window is in the opened position but with the escape ladder not illustrated for purposes of clarity of illustration;

FIG. 11 is a view similar to FIG. 9, illustrating a compression gasket in place, but not illustrating the lid, for purposes of clarity of illustration;

FIG. 12 is a perspective view similar to FIG. 11 illustrating the extruded, injection molded, milled, pulltrusion or other similar composite material lid in place with the compression gasket secured to the lid and a pressing relationship to the sill;

FIG. 13 is a perspective view of the inventive lid from the bottom, with the compression gasket removed;

FIG. 14 is a perspective view from the side of the removable lid;

FIG. 15 is a perspective view from the inside of the window of the inventive window illustrating the compartment for the ladder;

FIG. 16 is a perspective view of a reinforcing bar for the top of the frame;

FIG. 17 is a cross-sectional view along lines to 17-17 of FIG. 9 of an alternative embodiment of the present invention utilizing a leak preventing insert;

FIG. 18 is a cross-sectional view of the embodiment of FIG. 17 along lines 18-18 of FIG. 9;

FIG. 19 is a perspective view of a leak-preventing insert used in the embodiment of FIG. 19;

FIG. 20 is a view similar to that of FIG. 18 illustrating the structure of an injection molded, window sill incorporating the invention;

FIG. 21 is a cross-sectional view of an alternative embodiment of the inventive window also similar to FIG. 18 and showing a structure with a leak preventing lip and which is suitable for extrusion, pulltrusion, injection molding and milled type manufacturing;

FIG. 22 is a cross-sectional view illustrating an alternative method of reinforcing the inventive window assembly and a particularly advantageous method of insulating the ladder-containing compartment; and

FIG. 23 is a cross-sectional view of another alternative embodiment of the inventive window having an internally reinforced sill;

FIG. 24 is a diagrammatic view of yet another alternative embodiment of the inventive window having the ladder in the upper portion of the window;

FIG. 25 is a perspective view of yet another alternative embodiment of the inventive window having bar for keeping the ladder separated from the side of the building during use;

FIG. 26 is a perspective view of the ladder rung illustrated in FIG. 25; and

FIG. 27 is a diagrammatic view of still yet another alternative embodiment of the inventive window having the ladder in the side portion of the window.

### DETAILED DESCRIPTION OF THE DRAWINGS

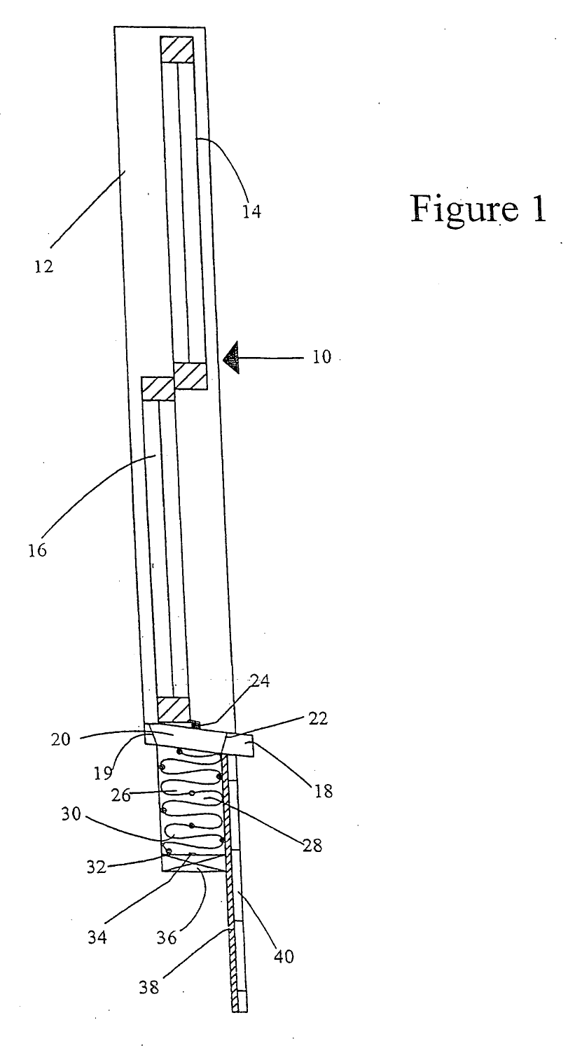

Referring to FIGS. 1-6, a double-hung window 10, enclosed in frame 12, comprises an upper sash 14 and a lower sash 16 shown in the closed position. The window 10 further comprises a sill 18 that has a hole 19 is cut into it in order to allow lid or bottom step 20 to be removed. The cuts are sealed with compression gaskets 22 in order to be weatherproof. The lid also has one or more handles 24 (only one is visible in FIG. 1), so that lid 20 can be removed easily.

Window 10 further comprises an extension box 26 to the window frame 12 which provides a storage area for escape ladder 28. Escape ladder 28 can be comprised of a combination of flexible rope like links 30 and steps or rungs 32 all of which should be made of fire resistant or fireproof material. Additionally, the escape ladder 28 can be made of metal or any other suitable material strong enough to withstand significant body weight. The specific materials for the escape ladder may vary widely, and many materials are known common to the trade.

Window 10 is designed for an emergency escape apparatus which is hidden unless in use. The escape ladder is stored in box 26 which is concealed within the wall cavity and is not visible when looking at the window. The storage box is only visible when sash 16 is open and handles 24 are lifted. Ladder 28 is secured to the bottom of the frame of the window using, for example, by a 5/16 inch or other appropriate sized eyelet 34. Referring to FIG. 1, the window frame is supported by a wood or steel house framing member 36 underneath and on the sides window 10 and plywood 38 on the outside of the containment box which helps provide the frame e with added strength to support body weight. Siding 40 is placed on the exterior of the plywood for aesthetic purposes.

When the user wishes to release the safety ladder 28, he or she would lift bottom sash 16, pull handles 24 and throw lid 20 from the window. Lid 20 then falls until the entire escape ladder 28 unravels. Once escape ladder 28 is completely unraveled and optionally the stand-offs are fully opened (deployed), the user may climb down steps 32 to safety.

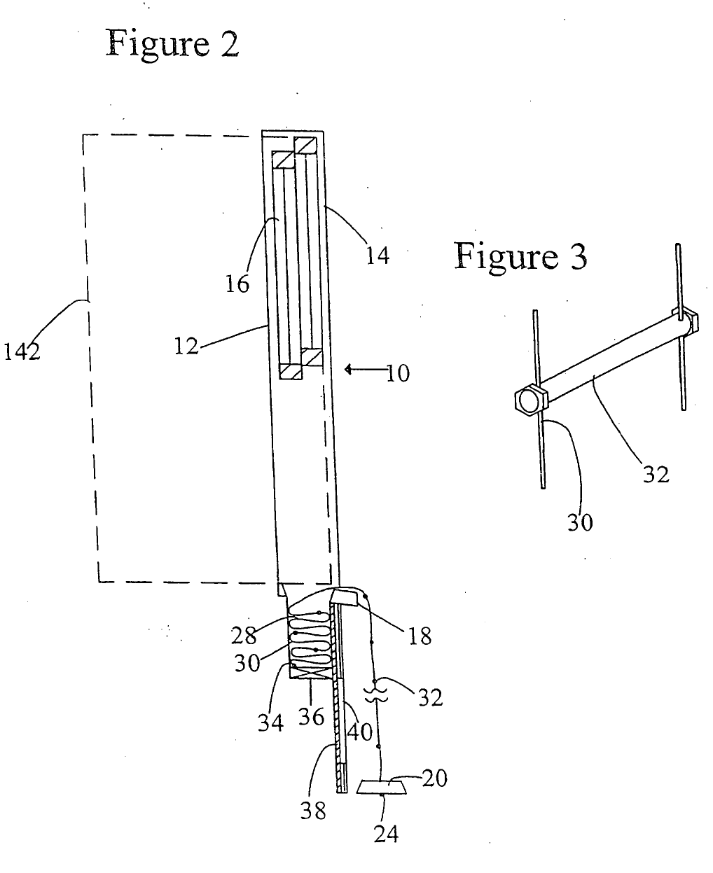

FIG. 2 shows a double-hung window 10 in the open position with the escape ladder ready for use. A portion of the sill 8 (or the entire sill) is cut to form lid 20, which can be removed and thrown from the window. Lid 20 now acts as the bottom step of the escape ladder 28. When lid 20 is thrown from the window, it acts as a guide for the remaining portion of the ladder to follow.

FIG. 2 further shows an alternative type of window that can accommodate the inventive technology. Casement window 142 can be opened in its usual manner and ladder 28 is released using the same method. The length of escape ladder 28 is determined by the height of the window above the ground or other escape path.

FIG. 3 is an enlarged perspective view of a portion of the escape ladder. The escape ladder can be made of a variety of materials, so long as it is lightweight, durable, can withstand significant body weight and is substantially fire proof.

Ladder 28 may be made to accommodate heights as high as the second floor, or higher height specification. The height specification of the ladder 28 is visibly marked on the window unit to ensure a proper installation. Alternatively, the height of the ladder may also be made adjustable by the consumer or the builder to meet any window height specification.

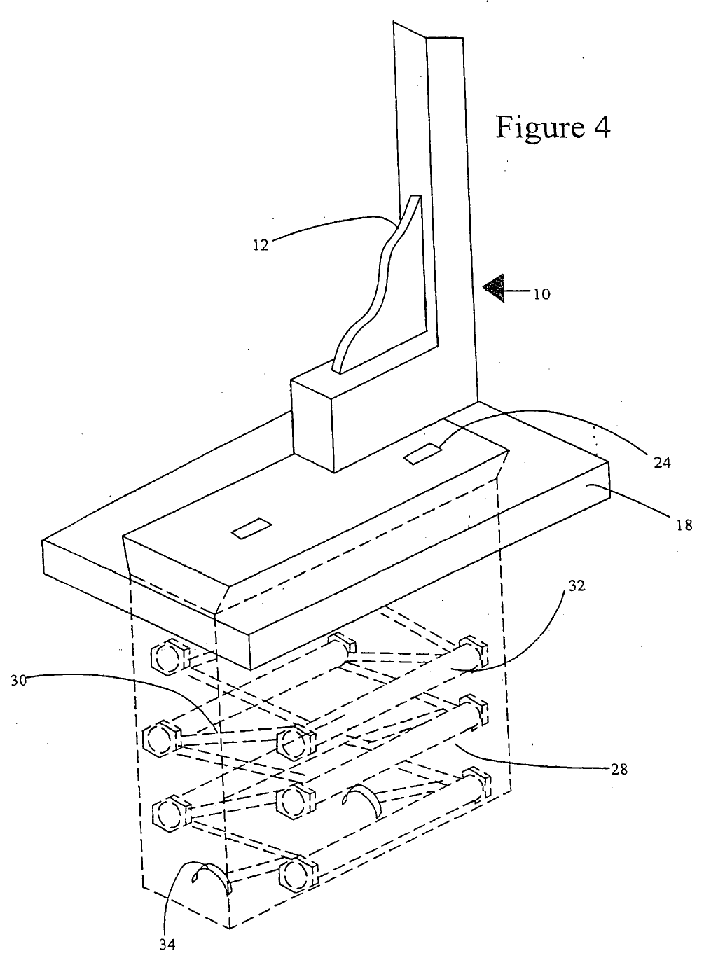

FIG. 4 shows a portion of the invention showing in detail how the escape ladder 28 will be stored. This view shows a closed window 10, that can be of any design. Sill 18 is shaped in order for lid 20 to be lifted out by handles 24.

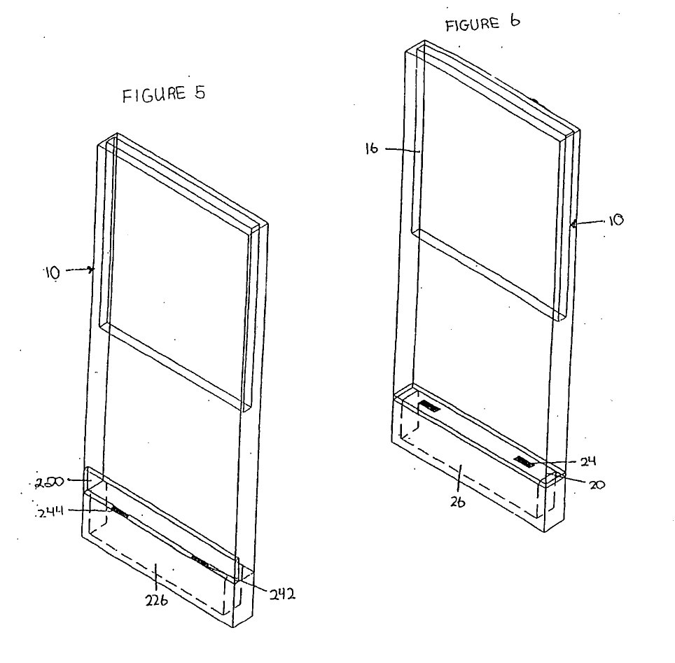

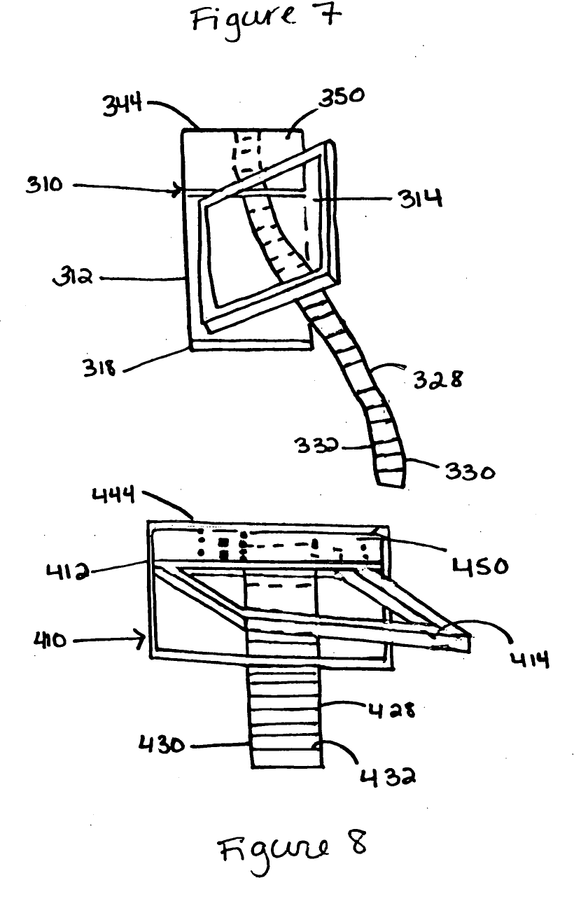

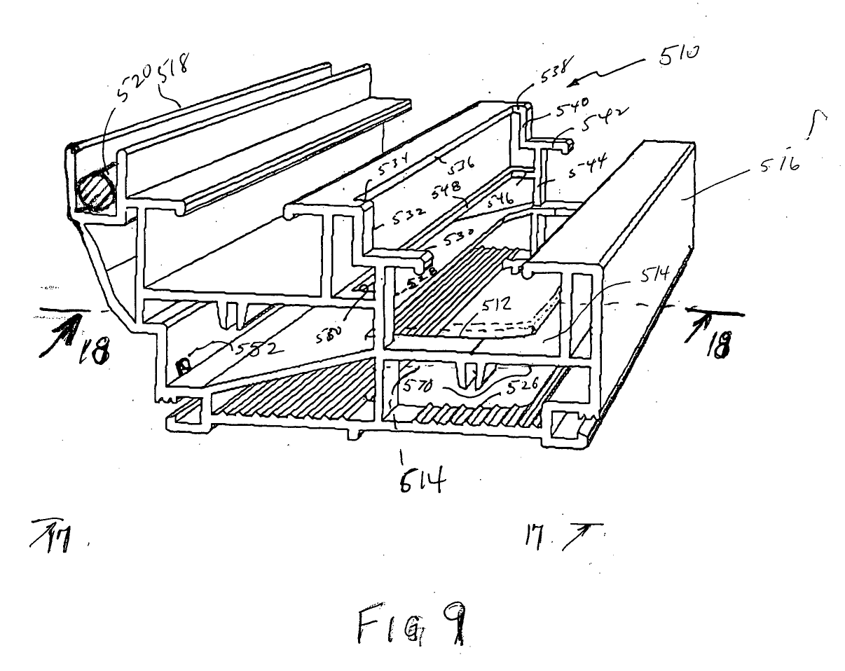

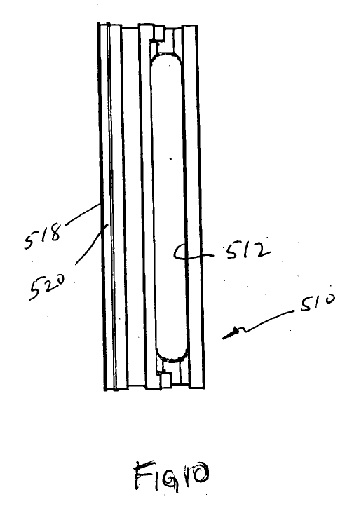

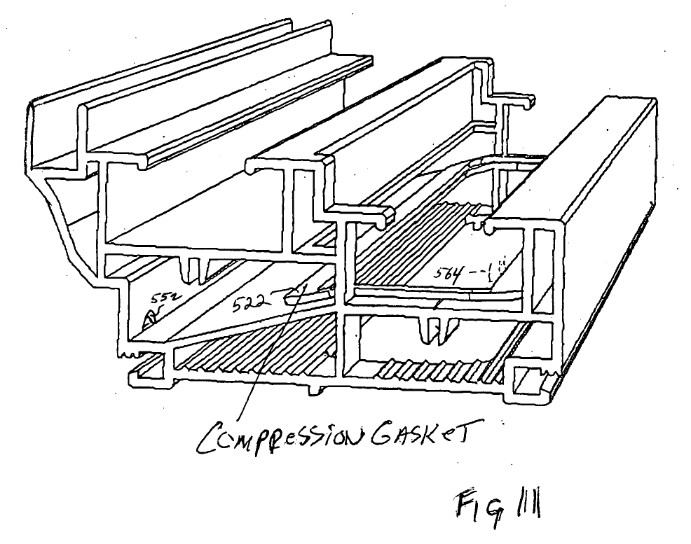

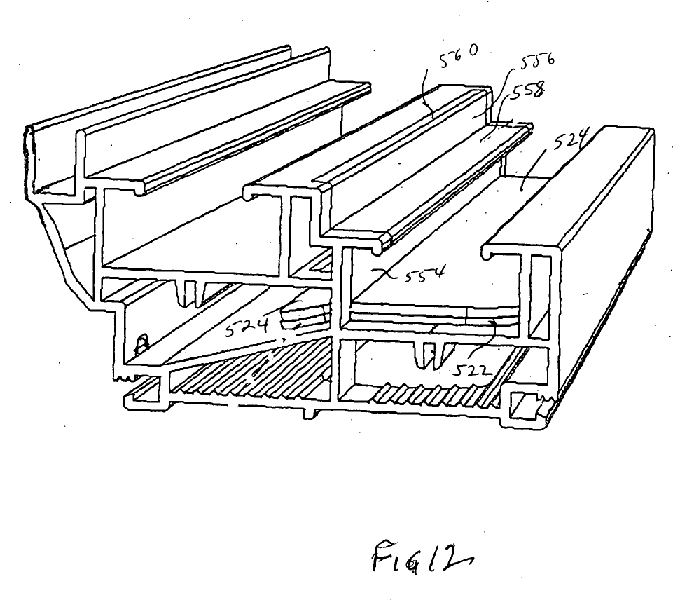

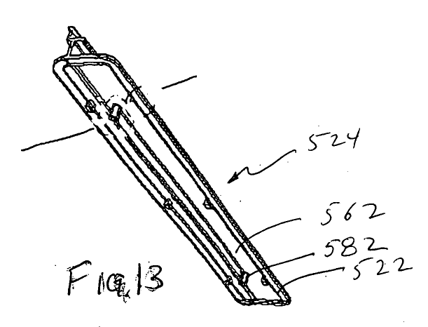

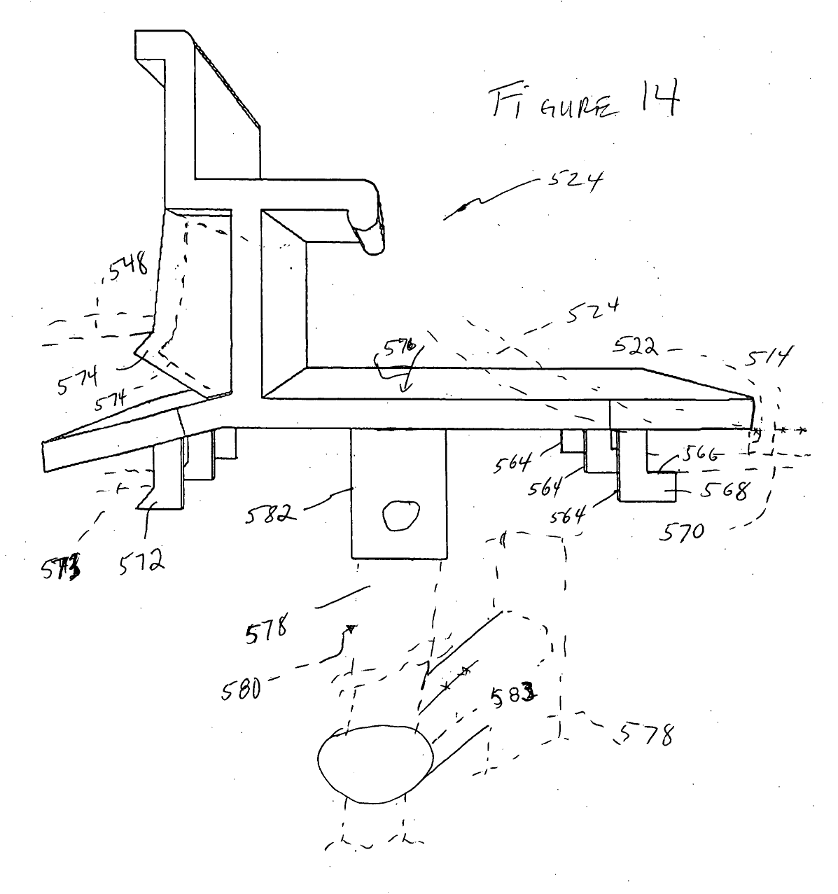

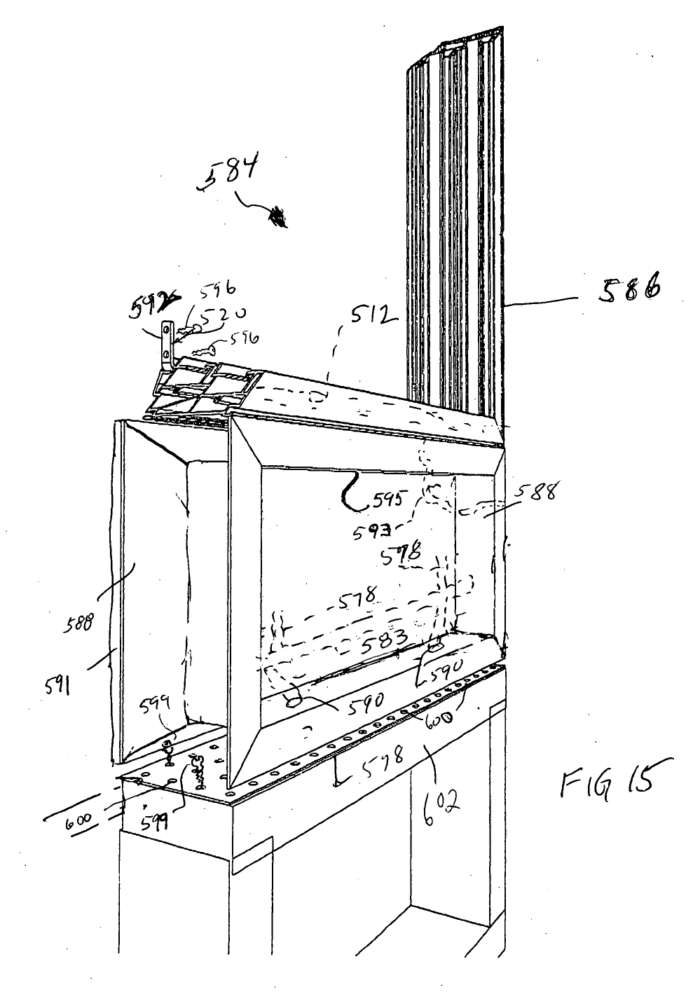

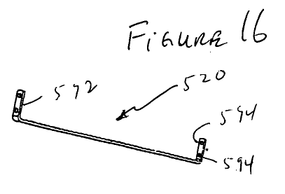

An alternative is to have lid 20 supported by hinges 242 and 244 as illustrated in FIG. 5. In FIG. 5, window 10 is in the open position. When the user opens the window 10, the hinged lid 220 can also be opened. The user can then reach into the storage compartment 226 and lift out the escape ladder.

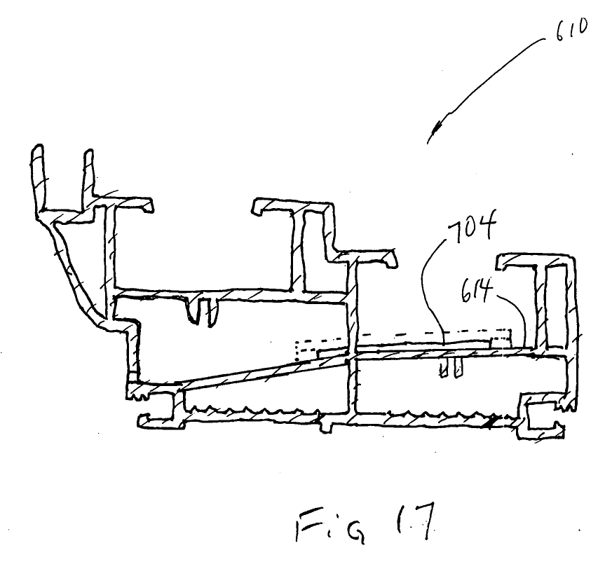

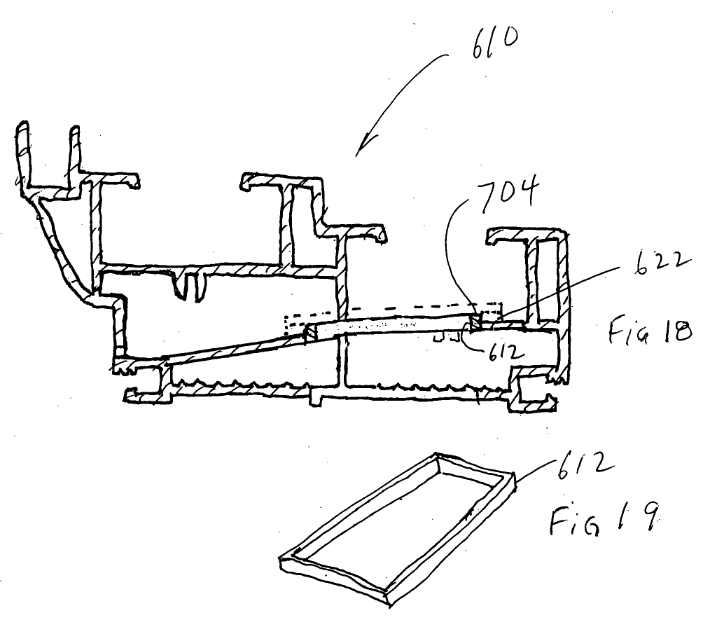

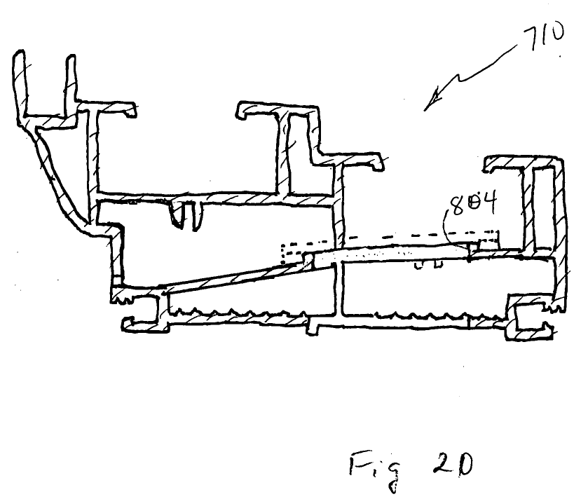

FIG. 6 shows a perspective view of the invention where the lid 20 is removable by handles 24. FIG. 6 shows a double-hung window in the open position without the ladder in use. Storage compartment 26 is not visible until lid 20 is removed. When lid 20 is removed, the escape ladder is exposed. In accordance with the invention, escape ladder 28 can either be attached to lid 20, in which case lid 20 acts as the bottom of the ladder, or the ladder can be placed in such a manner that the user can grasp it and throw it out the window.

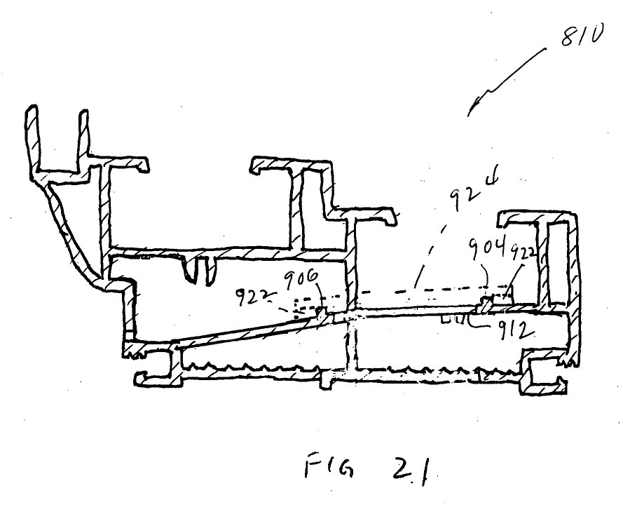

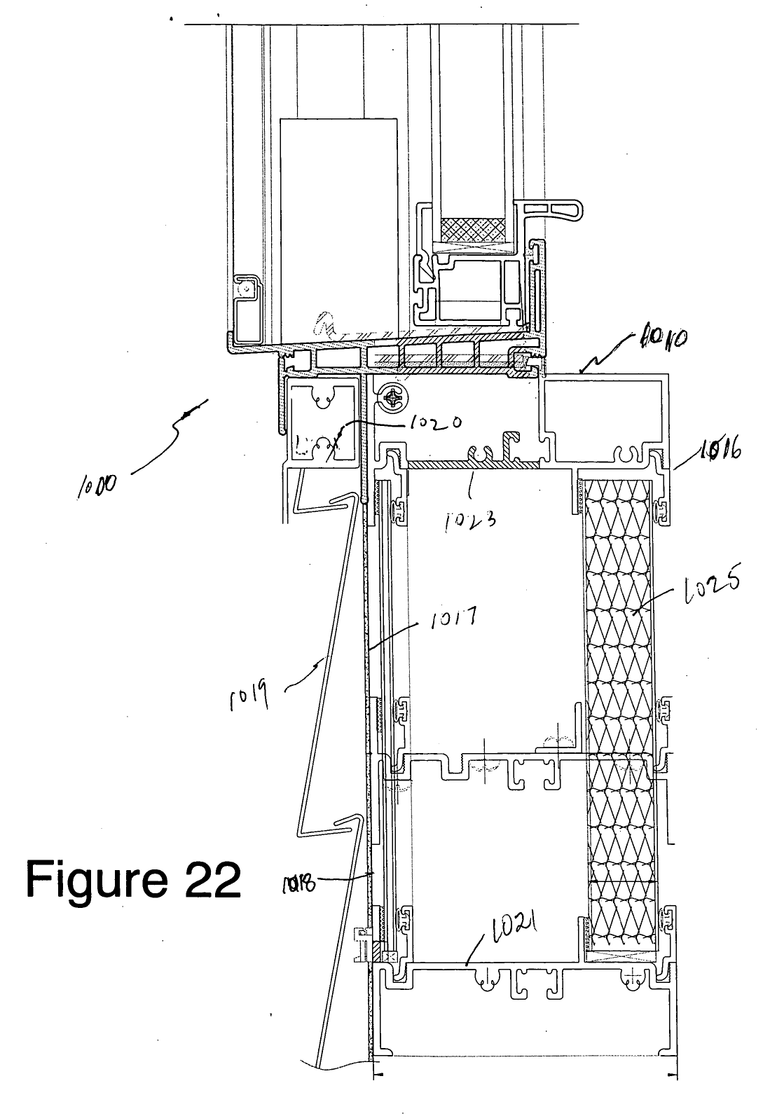

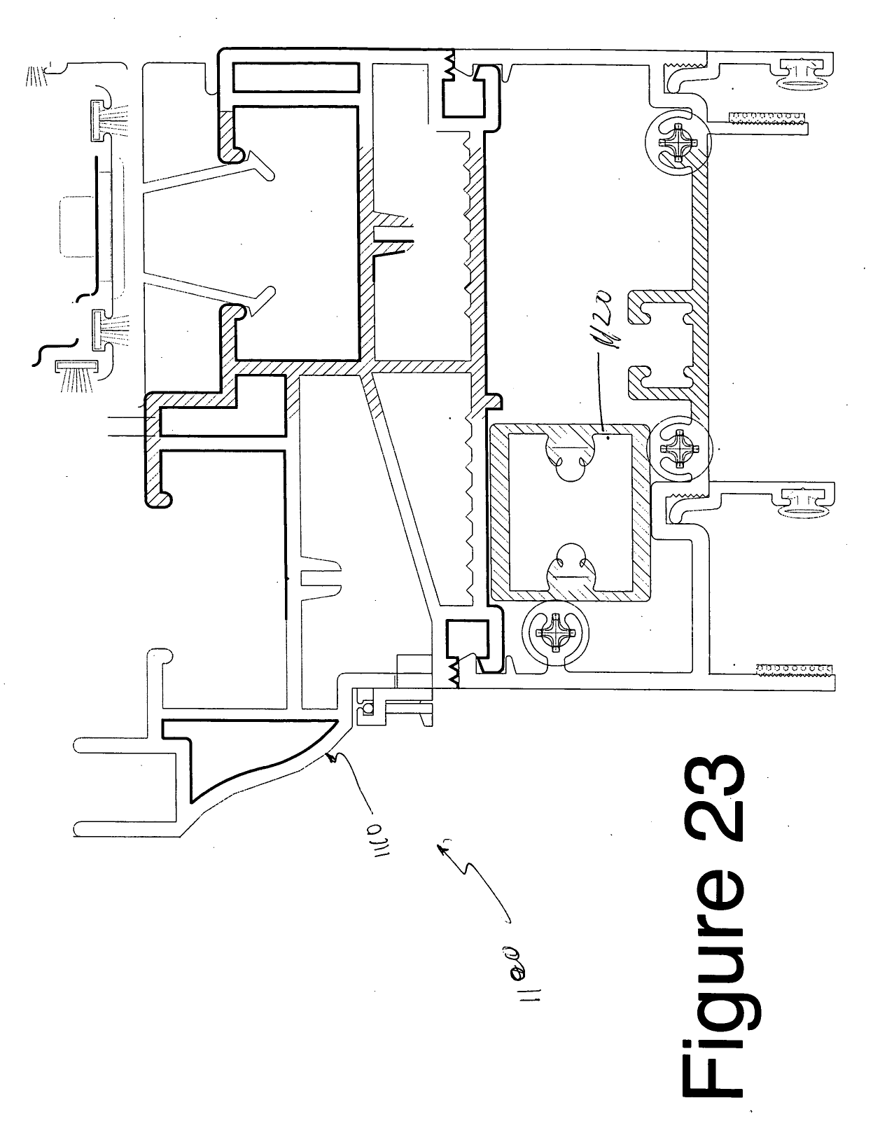

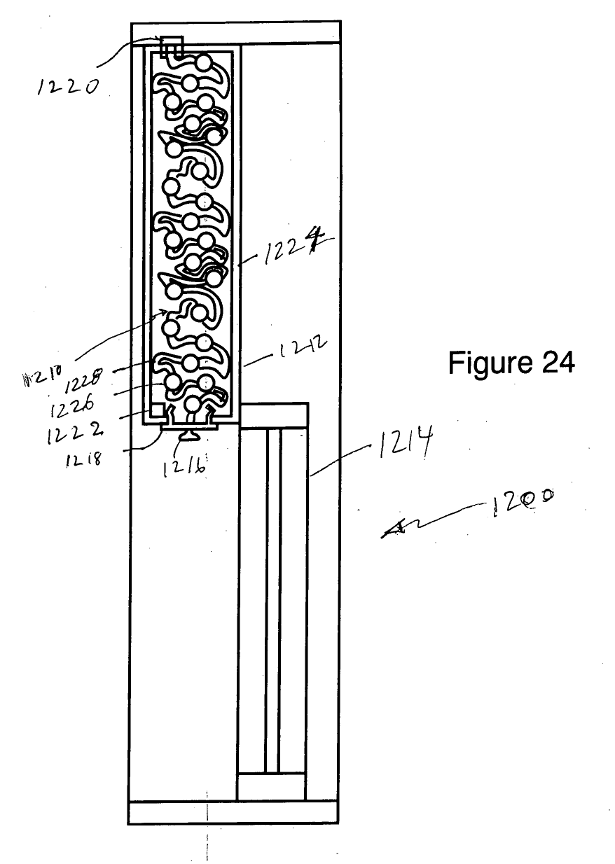

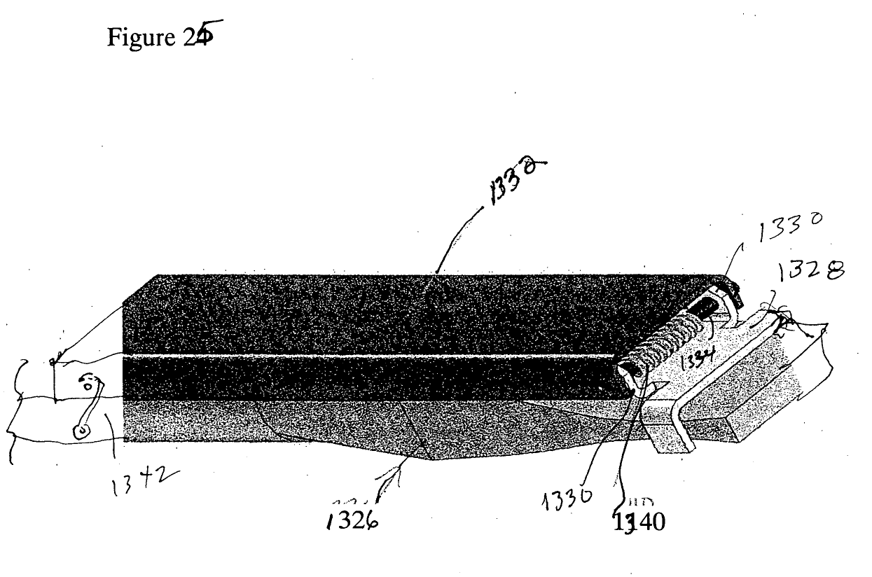

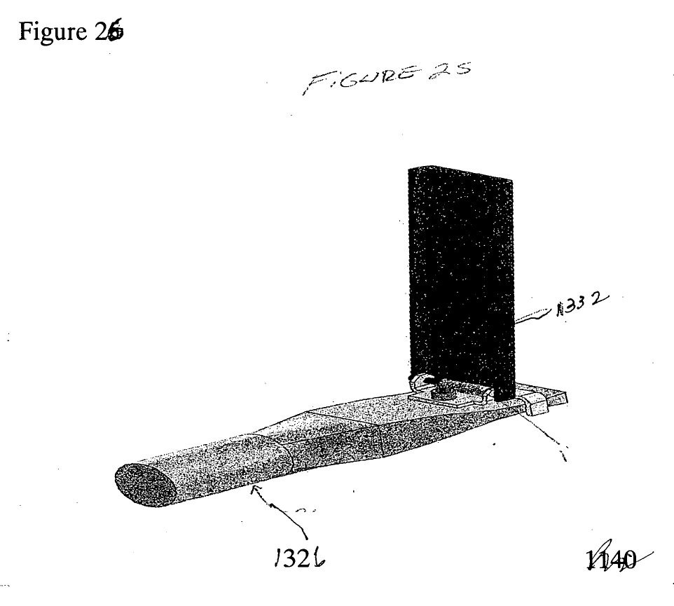

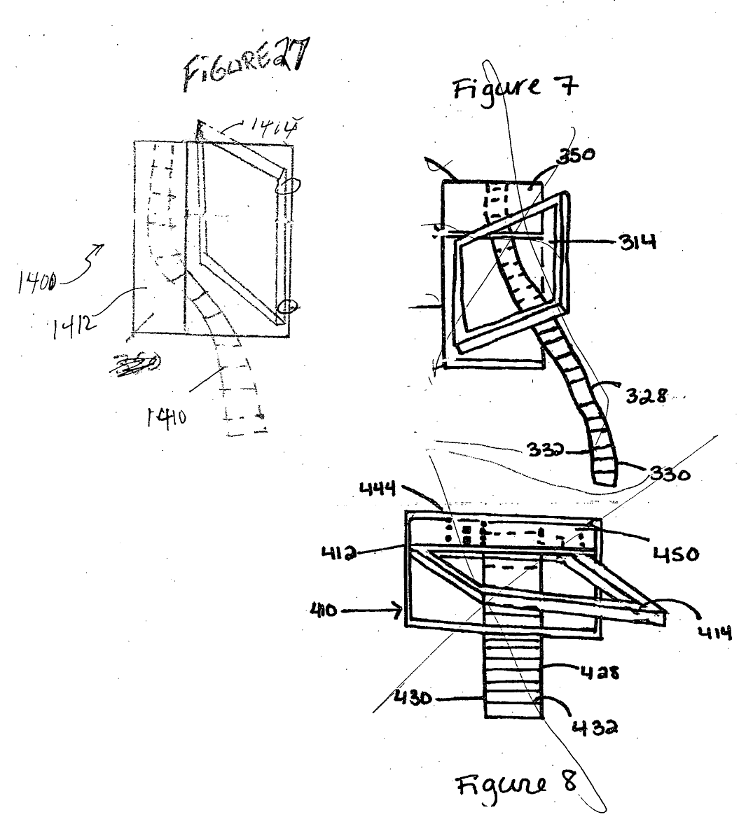

In most embodiments of the inventive escape ladder may be stored not only the bottom of the window, but also in the top or sides of the window frame. This is illustrated in FIGS. 7 and 8, this is a particular advantage because with the escape ladder stored in the top or the sides of the window there is additional protection from water penetration versus being placed on the sill of the window, as is described in detail below. FIG. 7 illustrates a casement window 310. Casement window 310 is comprised of a frame 312, a sill 318 and glass 314. FIG. 7 shows casement window 310 in the open position. Window 312 is cranked open in its normal manner and safety ladder 328 is released from compartment 350 at the top of the frame (FIG. 7) or the side of the window, as detailed below. Compartment 350 holds the escape ladder 328, which is comprised of links 330 and steps 332. This embodiment is an alternative method of storage for the inventive fire escape.

FIG. 8 illustrates an awning window 410 with glass 414 in the open position. The fire escape ladder 428 is designed to be released from compartment 450 at the top of the window frame 412. Escape ladder 428 is comprised of steps 432 and links 430. FIG. 8 illustrates a smoke hood 444 stored along side the fire escape ladder. This smoke hood hangs in compartment 450 and may be pulled out by the occupant. The smoke hood provides for ease of breathing while escaping from the burning building. In such a case where the escape ladder is stored in the top or sides of the frame, one method to expose the escape ladder would be to have a safety release button located near the bottom of the window. This would allow for any user to access the inventive escape ladder regardless of their height.

In addition to storing the hidden fire escape ladder, the storage box can be used for housing other items. For example, the storage can be used for additional safety devices such as emergency escape smoke hoods that can be used as a breathing apparatus. The storage could also be used as a hidden wall safe to store valuables and can be opened by a security code in the windows that do not contain a hidden fire escape.

Examples of alternatives to an escape ladder can be a knotted rope, a chute, a foldable ladder or any other escape device known in the field. It will also be understood that the escape device described herein can be designed to be suitable for adults, children, infants, or even pets.

Optionally, an ejector mechanism for ejecting the foldable ladder from the window may be employed.

Referring back to FIG. 1, in reference hole 19 may be cut into the sill or the top or sides of the window frame. In accordance with the invention, the sill they be cut open to facilitate opening or removal of the lid or bottom step in a number of ways. For example, the sill can be cut under the window sash and drainage channels can be placed on the underside of the remainder of the sill to drain off any water leakage to exterior weep holes placed in the front of the windows. Alternatively, the sill can be cut in any desired location dependent upon manufacture's existing design in order to minimize the potential of water leakage. Any number of channel type devices could be use to drain any water. The entire sill can be removed, or hinged from either the interior or exterior of the window to allow access to the fire escape ladder.

U-channels, L-channels or perforated tubes, by way of example, may be used to provide drainage channels that can be used to carry excess water to the exterior weep holes.

Similarly, compression gaskets, camper tape, bulb weather stripping, auto window weather stripping, foam rubber or sponge weather stripping, different types of weather stripping, or the like may be used to weatherproof the openings that allow access to the fire escape ladder portion of the inventive window. The extension box that provides a storage volume for the escape ladder may take a number of forms. For example the extension box can be constructed by extending the existing sides of the window frame and adding an additional bottom. Alternatively, mulling or joining a separate storage box to the existing window frame may be used in order to implement the present invention. Still yet another alternative is the invention by attaching a separate storage box to a window frame so as to allow an escape ladder access through the window frame. For example, one may use a fixed window without glass to be used as a storage box and mull it to an operating egress window.

Numerous types of handles many be used to allow the removal of the lid or sill or top or sides of the window from the inventive window so as to allow access to escape ladder: A recessed thumb latch may be used to release the sill and allow the lid to be either removed or hinged. Alternatively, and an applied pull tab can provide the desired functionality or an extruded pull tab may be incorporated in the system during manufacture. Yet another alternative is the use of a raised thumb latch that recesses into the bottom of the window sash. As noted above, one may also employ hooks or eye hooks. In accordance with the invention, it is also contemplated that decorative members may be used, such as decorative handles. It is also possible to employ a continuous handle that is attached to the lid that can also act as a weather sealant.

Also a cover can be used to seal the lid. The cover can be an additional sill or false sill or similar type devices that can be held on by snap legs or compression snaps that cover the entire sill and can be removed to allow access the lid in order to access the fire escape ladder.

Likewise various types of hinges may be employed to open the lid in order to allow access to the fire escape. These include plain bearing hinges, ball bearing hinges, spring hinges, pivot hinges, wrap around hinges, semi concealed or concealed hinges, tubular hinges, piano hinges, continuous hinges, or special purpose hinges.

In similar fashion, various types of anchors or supporting devices can be used to support the weight of the safety ladder, such as lag screws that are screwed through the bottom of the ladder into the window sill framing. The bottom of the storage box can be reinforced with steel bars or plates and the ladder can be screwed securely to one or more reinforcing bars. The sides of the storage box can be reinforced with steel or metal reinforced supports and the ladder can be anchored to the side supports.

Turning to FIG. 9, an alternative embodiment of the invention suitable for application to an extruded, injection moulded, pulltruded, or milled vinyl or aluminum window is illustrated. Generally such modern windows comprise a number of members having various profiles and forming the sill, top and sides of the window frame, within which a sash containing a glass window, for example, slides. More particularly, a sill 510 having a conventional profile is provided with a hole 512 which may be cut into the inner top surface 514 on the inside 516 of sill 510. In accordance with the invention it is contemplated that hole 512 is covered with the lid, as is more fully described below, and that the lid is removed to allow removal of the fire escape ladder in much the same manner as the embodiments of FIGS. 1-8.

Referring to FIG. 10, hole 512 may extend substantially the entire length of a sill 510. In order to bear the weight of the individual using the ladder, the outside 518 of the sill is provided with a reinforcing steel bar 520 which may be secured at its ends by screws to the sides of the window frame, as appears more fully below.

A suitable seal may be provided by a sealing member, such as a compression gasket 522 as illustrated in FIG. 11. Normally, gasket 522 would be secured to a lid 524, as illustrated in FIG. 12. However, in FIG. 11 the gasket is illustrated without the lid for purposes of clarity of illustration. Gasket 522 is secured to lid 524 using any suitable adhesive, such as a silicone adhesive, contact adhesive, double stick tape or the like.

Generally, the window sill structure illustrated in FIG. 9 is manufactured in a conventional fashion (a molded or formed application as described above) and comprises a vinyl or aluminum profile. The profile is then miter cut, butt jointed, ship lapped or other type mitering at the ends to create 45 degree or 90 degrees cuts which mate with similar cuts at the base of the vertical portions of the frame. The profile is also cut, for example with a band saw router or similar type tools, to create a lower hole 526, and upper hole 512. Holes 512 and 526 may be cut simultaneously. In similar fashion, other portions of the aluminum or vinyl profile are removed by cutting along the best generally defined between hole 522 and ages 528, 530, 532, 534, 536, 538, 540, 542, 544, 546, 548 and 550, as illustrated in FIG. 9. The sill structure is completed by the drilling of a weep hole 552 to provide drainage for water which may into the system when, for example, a window is left open and it rains. Such cutting may be done using any suitable tool, such as a heated blade, band saw, or the like. While, in principle, it is possible to form the sill illustrated in Figure nine by injection molding, the above this guide process carries the advantage of allowing the use of conventional and existing equipment with minimal investment in additional equipment and manpower to achieve the advantages of the inventive system in a modern extruded profile window frame.

As shown most clearly in FIG. 12, lid 524 is disposed over hole 512 in the sealing position. Moreover, it urges gasket 522 against top surface 514, compressing gasket 522. At the same time, vertical portions 554 and 556 of lid 524 are in mating relationship with edges 528 and 544, and edges 532 and 540, respectively. Similarly, horizontal portions 558 and 560 of lid 524 are in mating relationship with edges 530 and 542, and edges 534 and 538, respectively. Thus, laid by 24 replaces the functionality of all portions of the window sill removed, as discussed above, from the formed vinyl or aluminum profile.

Lid 524 may be maintained in the position illustrated in FIG. 12, by any suitable mechanical mechanism, as may be seen with reference to FIGS. 13 and 14. In accordance with the illustrated embodiment of the invention, lid 524 generally comprises a thin planar member 562 to which a compression gasket 522 is secured, compression gasket may also be applied to 514 as illustrated in FIG. 9. Lid 524 for the comprises a number of retainer legs 564 which include engagement surfaces 566 at the top of their respective feet 568. Retainer surfaces 566 engage the bottom 570 (FIG. 1) below top surface 514.

In similar fashion, snap legs 572 snap over edge 573. Finally, snap retaining surfaces 574 steps over edge 548. Such snapping engagement is achieved by first engaging feet 568 under surface 570 with retaining surfaces 574 and snap legs 572 positioned above edge 548 and edge 573, and then rotating lid 524 (as illustrated in phantom lines in FIG. 14) counterclockwise in the direction indicated by arrow 576, until the lid 524 assumes the position illustrated in FIG. 12.

Snap legs 572 tend to urge lid 524 into compressing engagement with gasket 522, thus providing a good seal and preventing water from penetrating.

In connection with the preferred embodiment of the invention, it is noted that in the illustrated embodiment, sill 510 is made up flexible vinyl and thus flexes to accommodate the insertion of lid 524. Alternatively, the lid may be made flexible to accommodate its being snap into position on top for example, a rigid aluminum or rigid vinyl sill.

In accordance with the invention, it is contemplated that the lid may be used to pull out the ropes 578 of a ladder 580. Accordingly, in accordance in the invention, lid 524 is provided with a pair of screw bosses or posts 582 which are secured to the two ropes 578 which together with rungs 583 make up the ladder.

In accordance in the invention, the inventive window unit 584 comprises a frame 586 within which the sash slides. A compartment made of a rigid rectangular frame 588 is made of miter cut extruded aluminum profile having a U-shaped cross-section. Frame 588 is provided with a pair of holes 590, which receive bolts to secure the ropes 578. The compartment is completed by a pair of inner and outer plates 591 and 593 (partially cut away). Of course, any suitable material or structure may be used to accomplish the anchoring of the ropes and receptacle function needed for the fire escape ladder 580. The compartment defined within frame 588 and between plates 591 and 593 is accessible through a hole cut in top surface 595 of frame 588 below hole 512.

As alluded to above, the sill is reinforced by a steel reinforcing bar 520 (FIG. 16) which has a pair of arms 592. Arms 592 are provided with holes 594. Holes 594 receive screws 596 which secure arms 592 to the sides of the window frame unit within which the sash slides. Finally, a perforated steel plate 598 is welded to the bottom of frame 588. Plate 598 includes holes 600. Screws 599 may be used by passing the same through holes 600 and securing them to the wooden framing of a house or other structure for example, by securing them to, for example wooden, stud 602 of the framing members of a private home of conventional wood frame construction.

In accordance with the invention, liquids falling on the sill are prevented from passing below the sill by lid 524, which acts as an effective seal on account of the pressure exerted against gasket 522. Thus, water is caused to pass over surface 514 and flow toward weep hole 552. In the event of a fire, lid 524 may be removed by gripping surface 560 and pulling clockwise opposite the direction indicated by arrow 576. Lid 524 may then be thrown outside the building, carrying the fire escape ladder with it to provide a means for escape from the building.

An alternative embodiment of the present invention is illustrated in FIG. 9 in phantom lines. More particularly, in accordance with this embodiment, all parts of surface 614 of the sill are slanted to promote the flow of water toward the weep hole. Such embodiment of sill 610 is illustrated in FIG. 17. In addition, an insert 704 acts as a wall promoting the flow of liquid away from hole 612, as illustrated most clearly and FIG. 18. In accordance with the invention it is contemplated that wall 612, which is separately illustrated in FIG. 19, would be glued with a continuous bead of glue within the cut out or made integral with the sill through previously mentioned methods, and would serve to prevent water flow below the frame in the event that gasket 622 is not seated properly or has deteriorated over time.

FIG. 20 illustrates yet another embodiment of the invention. Here wall 804 is molded integrally with the rest of sill 710. In this case, it is contemplated that sill 710 would be made by injection molding.

Still yet another possibility is illustrated in FIG. 21. Here, the wall is extruded but is not continuous, extending only along the length of the sill 810 in the form of an inside wall 904 and an outside wall 906. This embodiment is manufactured in the same fashion as the embodiment of FIG. 9, a hole 912 being cut in the extruded profile, and the whole being sealed by the gasket 922 of lid 924.

Referring to FIG. 22, an alternative embodiment of the inventive window 1000 is illustrated in cross-section. Window 1000 includes a sill member 1010 which is reinforced by an aluminum bar profile 1020, which is cut to size and slipped into a slot defined in sill member profile 1010. Aluminum bar profile is secured to the buildings wall framing via steel nailing fins, thus adding the maximum support for window 1000 when the fire escape ladder is being deployed. The fire escape ladder is not shown here for purposes of clarity of illustration. In addition, window 1000 includes an insulated member supporting extrusions 1021. Extrusion 1023 is removed so the escape ladder can be pulled up through the opening in the window. The escape ladder is stored in the compartment between insulated panel 1025 and wind barrier 1017. Panel 1025 is an insulated panel providing insulating qualities to the building. Thus, even if the inventive window bears up against the wall board of the room at its inside surface 1016 and against moisture permeable wind barrier 1017 and siding 1019 on its outside surface 1018, even in the absence of the normal insulative material found in other parts of the wall of the building, heat loss will be largely attenuated.

Still yet another approach is illustrated in FIG. 23. Here window assembly 1100 comprises a sill 1110 which is reinforced internally by a metal reinforcement bar 1120.

In accordance with the invention, a window assembly 1200 may contain a fire escape ladder 1210 in an upper nonmoving compartment 1212. In this embodiment, compartment 1212 does not move, but window 1214 moves up and down in a conventional manner. When it is desired to use the fire escape ladder 1210 in the inventive window, window 1214 is slid upwardly and knob 1216 of lid 1218 is pulled, releasing ladder 1210. Ladder 1210 is supported by reinforcement bar 1220 and is prevented from damaging the window by reinforcement bar 1222.

In accordance with a preferred embodiment of the invention, compartment 1212 may be decorated on the inside with a picture, or other decorative member. For example, it may be formed of a stained-glass member 1224. In connection with this, rungs 1226 of the ladder may be made transparent to increase the amount of light output by the system. Likewise, rope 1228 may be made white in color.

Still yet another alternative embodiment of the invention is illustrated by rung 1326 which includes a support member 1328 with a pair of supports 1330 which hingedly support a standoff 1332. The hinging mechanism is completed by a pin 1334 on which a spring 1340 is mounted. In accordance with the invention, it is anticipated that a pair of standoffs would be mounted at opposite ends of rungs every five to nine feet along the length of the ladder, or at smaller spaces.

During use, when the ladder incorporating rungs 1326 is pulled from the inventive window, standoffs 1332 spring forward, as illustrated in FIG. 26. A latching mechanism 1342 may be employed to keep rungs 1326 adjacent standoffs 1332 when not in use.

Another alternative is that the ladder can be released by hinging the outer skin or panel, and springing it open in response to actuation of an interior button, turn handle, cam type operator or other mechanism that allows the outer skin to be released.

When the stand-off is fully deployed it keeps the escape ladder step a safe distance away from the house and creates room for foot and hand holds making descending the escape ladder easier and safer.

Referring to FIGS. 25-6, the stand-off may be kept in the closed position and held in place by indentations in the ends so as to hold the stand-off in place while concealed within the storage compartment, the stand-off may also be held in place with Velcro or other similar type devices. The spring deploys the stand off to a 90 degree position so it can keep the rungs of the ladder away from the house to ease in escape while descending the escape ladder.

As illustrated in FIG. 27, the inventive window 1400 may include a ladder 1410 stored in a compartment 1412 on the side of, for example, a casement window assembly including a side hinging window 1414.

While illustrative embodiments of the invention have been described above, it is, of course, understood that many and various modifications will be apparent to those of ordinary skill in the relevant art, or may become apparent as the art develops. Such modifications are contemplated as being within the spirit and scope of the invention or inventions disclosed in this specification.

1. A window assembly configured as a single unit suitable for incorporation as a unit into a building during construction of said building or to be retrofitted into an existing building, comprising:
(a) a pane supporting frame assembly, said frame assembly comprising:
(i) a frame, defining a hole; and
ii) at least one sash, said sash supporting a pane, said sash being movably supported in said frame, said sash being movable between a closed position, and an open position where said frame defines an opening large enough to allow a person to pass through said opening;
(b) a containment structure defining an internal volume, said containment structure supported adjacent to, and attached to or integral with said pane supporting frame assembly, said containment structure defining an internal volume and an opening in communication with said hole;
(c) a closure member supported at a position closing said hole and said containment structure, said closure member being moveable from said position closing said containment structure to a position where said internal volume is accessible through said opening; and
(d) a foldable ladder secured to said pane supporting frame assembly and contained within said volume, said ladder being configured to be removed from said containment structure through said hole and said opening.

2. A window assembly as in claim 1, wherein said pane supporting frame is a casement window assembly, an awning window assembly, a double-hung window assembly or any operating window assembly configured and dimensioned for use as an egress.

3. A casement window assembly as in claim 2, wherein said window assembly comprises a sill and said hole is defined in said sill.

4. A window assembly as in claim 1, wherein said frame is an extruded member and further comprising a gasket disposed between said frame and said closure member.

5. A window assembly as in claim 4, wherein said frame is a flexible vinyl extruded member and further comprising engagement structure attached to or integral with said closure member and configured to position said closure member adjacent to said frame.

6. A casement window assembly as in claim 3, wherein said closure member is attached to the end of said foldable ladder.

7. A window assembly as in claim 1, further comprising a sidewall structure preventing water from entering said hole.

8. A window assembly as in claim 5, further comprising a sidewall structure preventing water from entering said hole, said sidewall structure comprising a pair of extruded walls extending the length of the frame and comprising an outside side wall and an inside side wall.

9. A window assembly as in claim 1, wherein said foldable ladder is made of fireproof materials.

10. A window assembly as in claim 1, wherein said containment structure and said pane supporting frame assembly are a single component and share a common structural member, and wherein said ladder is secured to said common structural member.

11. A double-hung window assembly as in claim 10, wherein said frame of said window assembly comprises a sill, top and sides of said window assembly.

12. A double-hung window assembly as in claim 11, wherein a portion of said closure member is a lid.

13. A double-hung window assembly as in claim 1, wherein said frame of said window assembly comprises a sill, top and sides of said window assembly, said closure member comprising a portion of said sill, said top or a sides of said window assembly.

14. A double-hung window assembly as in claim 13, wherein said removable closure member is a bottom step of said foldable ladder.

15. A double-hung window assembly as in claim 12, wherein said lid is supported by hinges.

16. A double-hung window assembly as in claim 15, wherein said hinges provide support for said lid to be opened and closed.

17. A window assembly as in claim 25, wherein said containment structure and said frame share a common member.

18. A window assembly as in claim 1, wherein said closure member is weather resistant.

19. A window assembly as in claim 1, wherein said closure member comprises handle structure.

20. A window assembly as in claim 1, wherein said window assembly is of the double-hung, casement, awning, slider or hopper type and is configured to be used for egress.

21. A window assembly as in claim 1, wherein said box and said window assembly comprise two separate components that are joined or mulled together.

22. A window assembly as in claim 1, comprising an ejector mechanism for ejecting said foldable ladder from said window assembly.

23. A window assembly as in claim 1, further comprising:
(e) a sealing gasket for sealing said closure member against said hole to weatherproof said closure member.

24. A window assembly as in claim 1, further comprising:
(e) a reinforcing member secured to said pane supporting frame assembly, said foldable ladder being secured to said reinforcing member.

25. A window assembly as in claim 23, wherein said closure member extends into said hole, and, further comprising:
(f) a gasket for sealing said closure member against said hole to weatherproof said closure member.

26. A window assembly as in claim 1, wherein said hole is defined in said frame at a position adjacent said at least one sash.

27. A window assembly as in claim 1, further comprising:
(e) a reinforcing member secured adjacent to or internally of said sill at a position where it helps to bear the weight of said foldable ladder when said foldable ladder extends from said window assembly.

28. A window assembly, comprising:
(a) a pane supporting frame assembly, said frame assembly comprising:
(i) an extruded, injection moled, pulltruded, or milled profile frame member comprising defining a hole; and
ii) at least one sash, said sash supporting a pane, said sash being movably supported in said frame, said sash being movable between a closed position, and an open position where said frame defines an opening large enough to allow a person to pass through said opening;
(b) a containment structure defining an internal volume, said containment structure supported adjacent to, and attached to or integral with said pane supporting frame assembly, said containment structure defining an internal volume and an opening in communication with said hole;
(c) a closure member supported at a position closing said hole and said containment structure, said closure member being moveable from said position closing said containment structure to a position where said internal volume is accessible through said opening;
(d) a gasket disposed between said closure member and said extruded profile frame member;
(e) retainer structure for retaining said closure adjacent said gasket; and
(f) a foldable ladder secured to said pane supporting frame assembly and contained within said volume, said ladder being configured to be removed from said containment structure through said hole and said opening.

29. A window assembly as in claim 1 wherein said containment structure insulated with insulation panels on either or both interior or exterior sides, and is supported by aluminum profiles and/or steel plates that help to provide structural integrity for the escape ladder.

30. A window assembly as in claim 1, wherein said full ladder comprises rungs and at least one standoff is hingedly mounted on one of said rungs.

31. A window assembly as in claim 30, wherein said hingedly mounted standoff is spring-loaded against one of said rungs.

32. A window assembly as in claim 1, whereas said containment structure has space sufficient to hold said ladder and a breathing apparatus such as smoke hoods and fire protecting apparatus.
